(19) United States
(12) Patent Application Publication
(10) Pub. No.: US 2009/0061175 A1
(43) Pub. Date: Mar. 5, 2009

(54) METHOD OF FORMING THIN FILM METAL CONDUCTIVE LINES

(76) Inventor: Sang-Hee KIM, Seoul (KR)

Correspondence Address: KED & ASSOCIATES, LLP, P.O. Box 221200, Chantilly, VA, 20153-1200, US

(21) Appl. No.: 11/960,092

(22) Filed: Dec. 19, 2007

(30) Foreign Application Priority Data
Aug. 31, 2007 (KR) 10-2007-0088543

(51) Int. Cl. C25D 5/00; B32B 3/00

(52) U.S. Cl. 428/209; 205/118

(57) ABSTRACT

Provided is a method of forming thin film metal conductive lines, the method including the steps of: forming a seed metal layer on a substrate; forming a first photoresist (PR) layer on the seed metal layer, and forming a metal conductive line pattern using the first PR layer as a mask; removing the first PR layer, and then forming a second PR layer which is spaced at a predetermined distance from the metal conductive line pattern; forming a protective film surrounding the metal conductive line pattern by electroplating; and performing etching to remove the second PR layer and an exposed portion of the seed metal layer.

### CROSS-REFERENCE TO RELATED APPLICATION

This application claims the benefit of Korean Patent Application No. 2007-0088543, filed Aug. 31, 2007, the disclosure of which is hereby incorporated herein by reference in its entirety.

### BACKGROUND OF THE INVENTION

1. Field of the Invention

The present invention relates to thin film metal conductive lines (hereinafter, referred to as metal conductive lines) and a method of forming the same, and more specifically, to metal conductive lines and a method of forming the same, which effectively prevents an undercut effect when ultra-precision conductive lines used in high-integration, high-frequency, high-precision conductive line substrates are formed, thereby forming high-integration, high-frequency, high-precision metal conductive lines.

2. Description of the Prior Art

Recently, as mobile communication technology is being developed, demand for size-reduced, composite, modularized, and high-frequency electronic components is increasing in the mobile communication technology field. To satisfy such demand, the precision of metal conductive lines (wiring lines) should be further increased.

FIGS. 1A to 1D are diagrams showing a conventional method of forming metal conductive lines. The metal conductive lines are formed by the following process. First, seed metal layers composed of Ti, Pt, and Al are sequentially formed by sputtering on a ceramic substrate containing more than 99.5% of alumina. The thicknesses of the seed metal layers are set to about 3000, 200, and 3000 Å, respectively. However, the thicknesses may differ depending on the field of application. Then, photoresist is coated on the substrate having the seed metal layers to form a photoresist (PR) layer, and the PR layer is partially removed in the form of metal conductive line pattern by using a photolithography process (FIG. 1A).

Next, on the seed metal layer exposed by partially removing the PR layer, a main metal layer is plated so as to form a metal conductive line pattern. The main metal layer is formed of Al by an electric plating method having excellent film-formation speed (FIG. 1B). Then, the PR layer is removed using strip equipment and chemicals (FIG. 1C). Further, the seed metal layer exposed on the substrate is etched by a wet etching method (FIG. 1D).

In such a method, it can be found that when the seed metal layer exposed on the substrate is etched by the wet etching, an undercut effect where the metal conductive line pattern is etched occurs, as shown in FIG. 1D. Therefore, it is difficult to form a precise conductive line pattern. Further, when seed etching is insufficiently performed, short-circuit defects occurs due to residue remaining on the seed metal layer. Such a problem becomes prominent as a circuit distance is reduced. In particular, when the substrate is a substrate for a probe card which requires high-precision impedance wiring characteristics or a multilayer wiring substrate used as mobile communication components, the output characteristic thereof is fatally affected, which makes it difficult to implement a multilayer wiring substrate requiring high integration and high precision.

Meanwhile, to prevent an undercut effect in a semiconductor manufacturing process, a method is proposed in which plating is performed on the outer surface of a conductive line pattern by electroplating or electroless plating. However, when bottom-up filling is not achieved on gap filling of a minute line width in a case of plating for implementing a substrate for the probe card which requires high integration and high precision, a seam or void is formed in the pattern. Such a seam or void may destroy an element due to an effect of short-circuited metal conductive line or electrolyte remaining in the void. Therefore, the formation of a protective film by a more enhanced plating method is required, when metal conductive lines for high-integration and high-precision substrate are formed.

Meanwhile, aluminum is usually used for a metal conductive line material. This is because aluminum has excellent conductivity, is easily processed, and has a relatively low price. However, the conductive lines formed of aluminum have limited implementation of the conductive line resistance required in high integration and high performance high-speed elements. Therefore, instead of aluminum, copper having low resistance and excellent Electro Migration (EM) characteristic needs to be used as a material of metal conductive lines.

### SUMMARY OF THE INVENTION

An object of the present invention is to provide thin film metal conductive lines and a method of forming the same, in which, when the thin film conductive lines are formed, a PR layer is formed to be spaced at a predetermined distance from a metal conductive line pattern formed on a high-integration and high-precision substrate, and a protective film is formed on the high-integration and high-precision metal conductive line pattern by an electroplating method using a magnetic field such that an undercut effect is prevented during etching.

According to an aspect of the present invention, a method of forming thin film metal conductive lines includes the steps of: forming a seed metal layer on a substrate; forming a first photoresist (PR) layer on the seed metal layer, and forming a metal conductive line pattern using the first PR layer as a mask; removing the first PR layer, and then forming a second PR layer which is spaced at a predetermined distance from the metal conductive line pattern; forming a protective film surrounding the metal conductive line pattern by electroplating; and performing etching to remove the second PR layer and an exposed portion of the seed metal layer.

When the electroplating is performed, a magnetic field may be applied by a magnetic field generator to perform the plating.

The intensity of the magnetic field may range from 400 to 1000 Gauss.

The metal conductive line may be a copper conductive line.

The substrate may be a substrate for a probe card or a multilayer wiring substrate used as mobile communication components.

The magnetic field generator may be provided with a permanent magnet or an electromagnet.

Each of the permanent magnet and the electromagnet may be composed of several layers.

The etching may be performed by wet etching.

The predetermined distance may be 0.1-2 μM.

According to another aspect of the invention, there are provided thin film metal conductive lines formed by the method according to the above-described aspect.

The metal may include copper.

The thin film metal conductive lines may be wiring lines for a probe card substrate or multilayer wiring lines used as mobile communication components.

### BRIEF DESCRIPTION OF THE DRAWINGS

The above and other objects, features and advantages of the present invention will be more apparent from the following detailed description taken in conjunction with the accompanying drawings, in which:

FIGS. 1A to 1D are diagrams showing a conventional method of forming metal conductive lines;

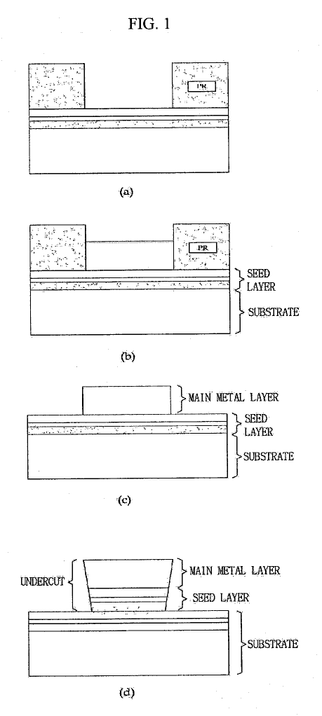

FIGS. 2A to 2J are diagrams showing a method of forming thin film metal conductive lines according to the present invention;

FIG. 3 shows correlations between the intensity of a magnetic field and a deposition rate of a plated film according to the present invention; and

FIGS. 4A to 4D show correlations between the intensity of a magnetic field and a step coverage according to the present invention.

### DETAILED DESCRIPTION OF EXEMPLARY EMBODIMENTS

Hereinafter, a method of forming thin film metal conductive lines according to an exemplary embodiment of the present invention will be described with reference to the accompanying drawings.

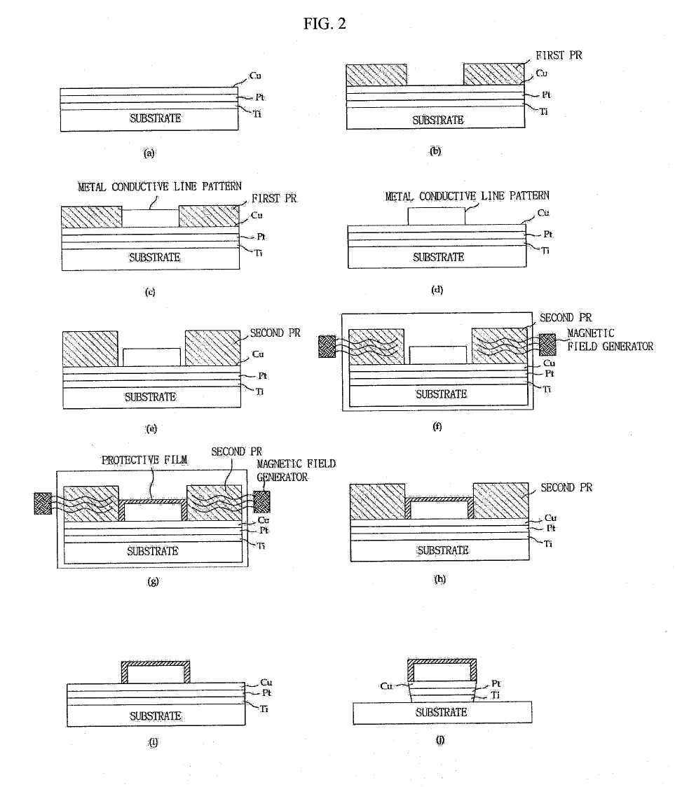

FIGS. 2A to 2J are diagrams showing a method of forming thin film metal conductive lines according to the present invention. The method of forming thin film metal conductive lines according to the present invention is performed as follows.

First, as shown in FIG. 2A, Ti, Pt, and Cu layers are sequentially formed on a substrate by an electroless plating method, a Chemical Vapor Deposition (CVD) method, or a Physical Vapor Deposition (PVD) method, thereby forming a seed metal layer (FIG. 2A).

A photosensitive PR film is coated on the seed metal layer. Then, a first PR layer is formed by an exposure and developing process (FIG. 2B). Using the first PR layer as a mask, a metal conductive line pattern is formed by an electroplating method (FIG. 2C).

After the metal conductive line pattern is formed, the first PR layer is removed (FIG. 2D). Then, a second PR layer is coated on the substrate on which the metal conductive line pattern is formed. In this case, the second PR layer is formed by the exposure and developing process so as to be spaced at a predetermined distance (for example, 0.1-2 ηm) from the metal conductive line pattern (FIG. 2E).

To form a protective film around the metal conductive line pattern, the electroplating is performed. When the electroplating is performed, a magnetic field is applied by a magnetic field generator (FIG. 2F). The application of the magnetic field may be performed using a permanent magnet or an electromagnet. For arbitrary magnetic-field distribution in a plating bath, the magnetic field generator may be disposed in various ways. For example, plural layers of electromagnets may be disposed around the plating bath such that the intensity of the magnetic field can be adjusted by the electromagnets.

Meanwhile, as for the plating method, there are provided an electroless plating method and an electroplating method. In the electroplating method, an excellent gap filling characteristic and high-speed growth can be achieved even in a wiring structure having a high aspect ratio. However, an EM characteristic is low and a chemical reaction is complex, which makes it difficult to perform control. In the electroplating method, a chemical reaction is relatively simple, handling is easy to perform, and an EM characteristic is excellent. However, a gap filling characteristic is low.

In the present invention, when the protective film is formed by the electroplating, the magnetic field is applied so as to improve the gap filling characteristic and growth speed. Then, a high-quality protective film can be formed on the minute metal conductive line pattern (FIG. 2H). When a magnetic field from the magnetic field generator (the electromagnet or permanent magnet) is applied in a direction perpendicular to a current direction during the electroplating, the mobility of plating ions is activated by the Lorentz force. Then, an excellent step coverage and gap filling characteristic can be realized in the minute pattern, and uniform plating can be achieved.

After the protective film is formed on the high-precision metal conductive line pattern by the above-described method, the second PR layer is removed (FIG. 2I), and the seed layer exposed on the substrate is removed by etching. Then, owing to the uniformly-plated protective film, an undercut of the metal conductive line pattern does not occur (FIG. 2J).

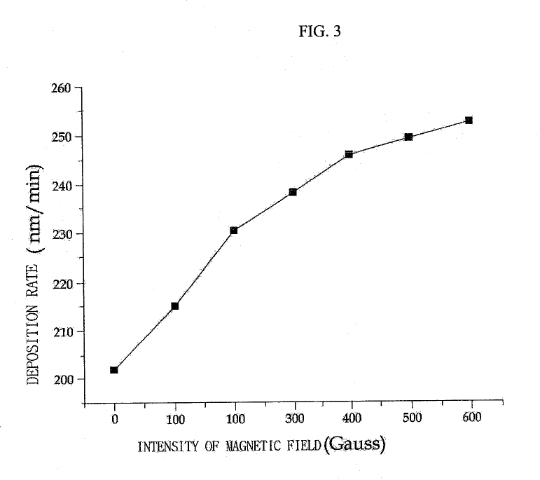

FIG. 3 shows correlations between the intensity of a magnetic field and a deposition rate (growth speed) of the plated film according to the present invention. As shown in FIG. 3, it can be found that as the intensity of the magnetic field increases, the growth speed increases. However, when the intensity exceeds 400 Gauss, the growth speed is slowed down.

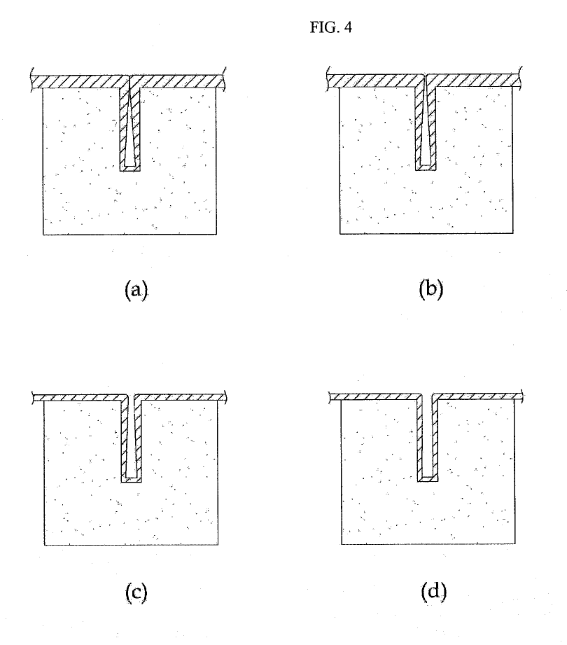

FIGS. 4A to 4D show correlations between the intensity of a magnetic field and a step coverage in a 1 ηm pattern having an aspect ratio of 5:1. As shown in FIGS. 4A to 4D, it can be found that when the intensity of the magnetic field ranges from 0 Gauss (FIG. 4A) to 200 Gauss (FIG. 4B), the edge thickness of the pattern increases due to imperfect plating, and the lower portion of a trench is not reliably plated, so that a void is formed. However, when the intensity of the magnetic field ranges from 400 Gauss (FIG. 4C) to 600 Gauss (FIG. 4D), the step coverage becomes excellent, and a void is not formed.

Therefore, when a magnetic field of more than 400 Gauss, or preferably, 400-1000 Gauss is applied during the electroplating in consideration of the deposition rate and gap filling characteristic of the plated film, it is possible to form a protective film for metal conductive line pattern, which has an excellent deposition rate and gap filling characteristic. In this case, a magnetic field of more than 1000 Gauss may be applied, although there may be no difference in effect as compared to the magnetic field of 400-1000 Gauss being applied.

According to the present invention, when a high-density substrate forming a high-density circuit is manufactured, such as a probe-card substrate or a multilayer wiring substrate used as mobile communication components, the PR layer is formed so as to be spaced at a predetermined distance from the metal conductive line in order to form the protective film around the metal conductive line pattern. Then, the protective film surrounding the metal conductive line pattern is formed in the space by the electroplating method. When the electroplating is performed, the protective film which increases plating speed and has an excellent gap filling characteristic is formed around the metal conductive line pattern, which makes it possible to prevent an undercut effect.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method of forming thin film metal conductive lines, the method comprising the steps of:
forming a seed metal layer on a substrate;
forming a first photoresist (PR) layer on the seed metal layer, and forming a metal conductive line pattern using the first PR layer as a mask;
removing the first PR layer, and then forming a second PR layer which is spaced at a predetermined distance from the metal conductive line pattern;
forming a protective film surrounding the metal conductive line pattern by electroplating; and
performing etching to remove the second PR layer and an exposed portion of the seed metal layer.

2. The method according to claim 1, wherein, when the electroplating is performed, a magnetic field is applied by a magnetic field generator to perform the plating.

3. The method according to claim 2, wherein the intensity of the magnetic field ranges from 400 to 1000 Gauss.

4. The method according to any one of claims 1, wherein the metal conductive line is a copper conductive line.

5. The method according to claim 4, wherein the substrate is a substrate for a probe card or a multilayer wiring substrate used as mobile communication components.

6. The method according to claim 3, wherein the magnetic field generator is provided with a permanent magnet or an electromagnet.

7. The method according to claim 6, wherein each of the permanent magnet and the electromagnet is composed of several layers.

8. The method according to claim 1, wherein the etching is performed by wet etching.

9. The method according to claim 1, wherein the predetermined distance is 0.1-2 μM.

10. Thin film metal conductive lines formed by the method according to claim 1.

11. The thin film metal conductive lines according to claim 10, wherein the metal comprises copper.

12. The thin film metal conductive lines according to claim 11, wherein the thin film metal conductive lines comprise wiring lines for a probe card substrate or multilayer wiring lines used as mobile communication components.
